(19) United States
(12) Patent Application Publication
(10) Pub. No.: US 2018/0335744 A1
(43) Pub. Date: Nov. 22, 2018

(54) IMAGE FORMING APPARATUS

(71) Applicant: Konica Minolta, Inc., Tokyo (JP)

(72) Inventor: Masakazu NAKAMURA, Tokyo (JP)

(73) Assignee: Konica Minolta, Inc., Tokyo (JP)

(21) Appl. No.: 15/969,918

(22) Filed: May 3, 2018

(30) Foreign Application Priority Data
May 19, 2017 (JP) 2017-099400

(51) Int. Cl. G03G 15/00

(52) U.S. Cl. CPC G03G 15/70; G03G 15/5029; G03G 2215/00721; G03G 2215/00548; G03G 15/657

(57) ABSTRACT

An image forming apparatus includes a transferer that transfers a toner image to a sheet and a fixer that thermally fixes the toner image transferred on the sheet by the transferer, and forms an image on the sheet, the image forming apparatus further including: a loop detector that detects a loop amount of a loop formed on the sheet between an upstream side conveying member and a downstream side conveying member that convey the sheet; and hardware processor that controls the loop amount on the basis of a detection signal of the loop detector, wherein the hardware processor performs prediction control of the loop amount in a case where it is determined that a distorted loop has occurred on the sheet on the basis of the detection signal of the loop detector.

The entire disclosure of Japanese patent Application No. 2017-099400, filed on May 19, 2017, is incorporated herein by reference in its entirety.

### BACKGROUND

### Technological Field

The present invention relates to an image forming apparatus.

### Description of the Related Art

Conventionally, an electrophotographic image forming apparatus is known that develops an electrostatic latent image formed on a photosensitive member with toner to form a toner image, transfers the formed toner image to a sheet by a transferer, and heats and fixes the transferred toner image by a fixer to form an image on the sheet.

In such an image forming apparatus, a conveying speed of the fixer fluctuates depending on variation in fixing roller diameters, variation in fixing loads, sheet thickness and surface property, a toner adhesion amount, temperature, and the like, so that there is a problem that a loop amount of a loop formed on the sheet varies between the transferer and the fixer.

In view of the above, a configuration is known in which a contact type loop detector is included between the transferer and the fixer, and the loop amount is kept constant by controlling the conveying speed of the fixer on the basis of the loop amount detected by the loop detector.

Specifically, in a case where the loop detector detects the loop (loop detection ON), control is performed to decrease the loop amount by increasing the conveying speed of the fixer. On the other hand, in a case where the loop detector does not detect the loop (loop detection OFF), control is performed to increase the loop amount by decreasing the conveying speed of the fixer. By repeating the above two types of control at predetermined intervals, it is possible to convey the sheet while keeping the loop amount constant (see FIG. 11). A constant loop amount means a position of a boundary at which the loop detector turns ON/OFF the loop detection.

However, in a case where a front/back difference (a difference between the front side and the back side of the apparatus) occurs between the conveying speeds of the transferer and the fixer, a difference in the loop amount increases between the front and back, so that there is a possibility that the loop shape is collapsed and a distorted loop occurs, and the contact type loop detector cannot detect the loop. Here, the distorted loop means a distorted state where there is the front/back difference in the loop shape. In a case where the loop detector cannot detect the loop, the loop detection is always in the OFF state (see FIG. 12) and the conveying speed of the fixer is always in the low speed state, so that the loop amount expands and loop excess occurs, and an upper loop occurs. When the upper loop occurs, image rubbing occurs due to contact to an upper panel or the like of the fixer. In addition, when the conveying speed of the fixer is always in the low speed state, the loop amount between the transferring and fixing cannot be kept constant, so that various problems occur such as sheet flip-up, transfer misalignment, and magnification failure. In particular, in an apparatus having a narrow space between the transferring and fixing to make the apparatus compact, an allowable amount is small of a conveying speed difference between the transferer and the fixer, so that it is difficult to keep the loop amount constant. In addition, in recent years, there has been a growing need for a long sheet whose length in the conveying direction exceeds 600 mm; however, in a case where the long sheet is used, it is difficult to control the loop amount, so that it is difficult to keep the loop amount constant.

In view of the above, a configuration is disclosed in which the loop can be detected by arranging a plurality of contact type loop detectors in the width direction of the sheet even in a case where the loop shape is collapsed and the distorted loop occurs (for example, see JP 2014-215430 A).

However, in the configuration described in JP 2014-215430 A, it is only possible to detect the loop at a position where each of the loop detectors is arranged, so that there is a problem that the loop cannot be detected depending on the shape of the distorted loop. In addition, an arrangement interval of the loop detectors varies depending on the size of a conveyed sheet, there is a problem that the loop cannot be detected depending on the sheet size.

### SUMMARY

An object of the present invention is to provide an image forming apparatus capable of keeping a constant loop amount even in a case where the front/back difference occurs between the conveying speeds of adjacent conveying members.

To achieve the abovementioned object, according to an aspect of the present invention, there is provided an image forming apparatus, reflecting one aspect of the present invention, that includes a transferer that transfers a toner image to a sheet and a fixer that thermally fixes the toner image transferred on the sheet by the transferer, and forms an image on the sheet,

the image forming apparatus comprising:

a loop detector that detects a loop amount of a loop formed on the sheet between an upstream side conveying member and a downstream side conveying member that convey the sheet; and

a hardware processor that controls the loop amount on the basis of a detection signal of the loop detector, wherein

the hardware processor performs prediction control of the loop amount in a case where it is determined that a distorted loop has occurred on the sheet on the basis of the detection signal of the loop detector.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating a schematic configuration of an image forming apparatus according to a present embodiment;

FIG. 2 is a functional block diagram illustrating a control structure of the image forming apparatus according to the present embodiment;

FIG. 3 is a side view illustrating a schematic configuration between a secondary transfer roller pair and a fixing apparatus;

FIG. 4 is a flowchart illustrating operation of the image forming apparatus according to the present embodiment;

FIGS. 5A and 5B are conceptual diagrams explaining prediction control in a waveform diagram illustrating a detection signal of a loop detector and a waveform diagram illustrating a conveying speed of a fixing roller pair;

FIG. 6 is a diagram illustrating an example of a table illustrating a correspondence between sheet types and a first predetermined period of time, a first period of time, and a second period of time;

FIGS. 7A and 7B are conceptual diagrams illustrating an example of control performed such that the first period of time is longer than the second period of time during the prediction control;

FIG. 8 is a side view illustrating a modification of the loop detector;

FIG. 9 is a perspective view illustrating another modification of the loop detector;

FIG. 10 is a flowchart illustrating operation of an image forming apparatus according to the modification;

FIG. 11 is a waveform diagram illustrating an example of the detection signal of the loop detector; and

FIG. 12 is a waveform diagram illustrating an example of a state in which the loop detector cannot detect a loop.

### DETAILED DESCRIPTION OF EMBODIMENTS

Hereinafter, one or more embodiments of the present invention will be described in detail with reference to the drawings. However, the scope of the invention is not limited to the disclosed embodiments.

An image forming apparatus 1 according to the present embodiment is a tandem type color image forming apparatus that forms a color image on a sheet by an electrophotographic system, on the basis of image data obtained by reading an image from a document, or image data received from an external device.

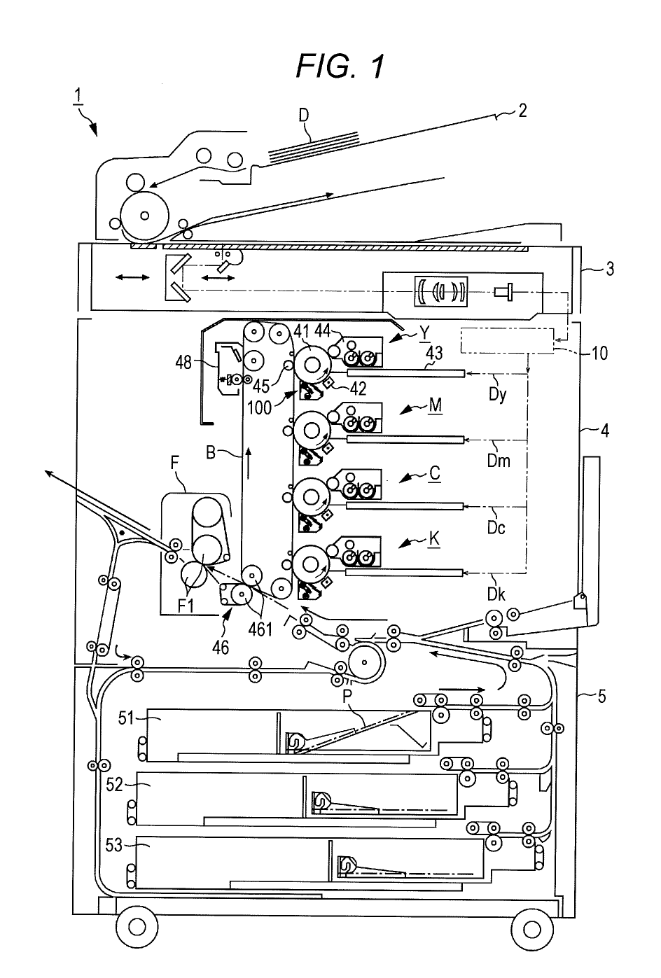

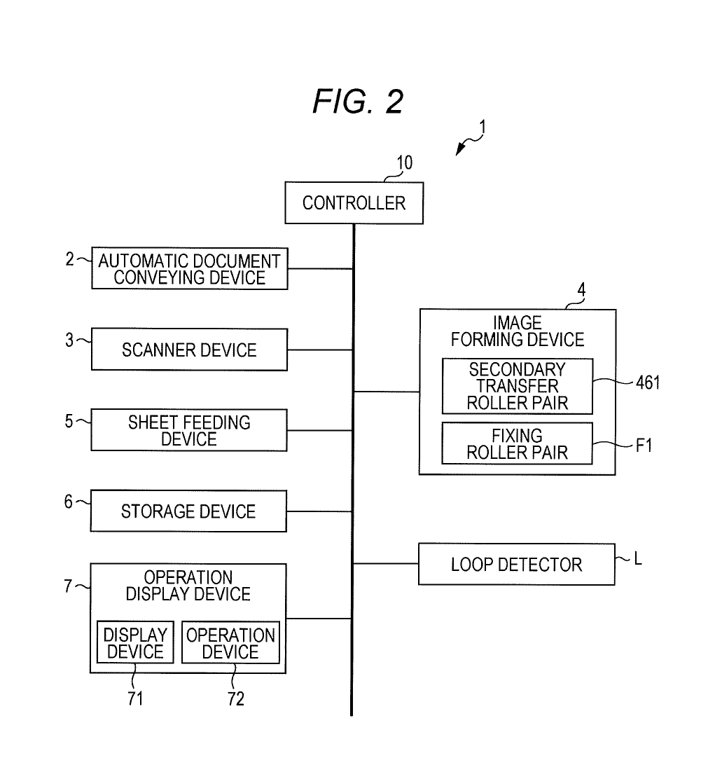

As illustrated in FIGS. 1 and 2, the image forming apparatus 1 includes an automatic document conveying device 2, a scanner device 3, an image forming device 4, a sheet feeding device 5, a storage device 6, an operation display device 7, and a controller 10.

The automatic document conveying device 2 includes a placing tray on which a document D is placed, a mechanism that conveys the document D, a conveying roller, and the like, and conveys the document D to a predetermined conveying path.

The scanner device 3 includes an optical system such as a light source and a reflecting mirror, and irradiates the document D conveyed on the predetermined conveying path or the document D placed on a platen glass with a light source, and receives reflected light. In addition, the scanner device 3 converts the received reflected light into an electric signal and outputs the signal to the controller 10.

The image forming device 4 includes a yellow image forming unit Y, a magenta image forming unit M, a cyan image forming unit C, a black image forming unit K, an intermediate transfer belt B, and a fixing apparatus F.

The image forming units Y, M, C, and K respectively form toner images of yellow, magenta, cyan, and black on a photosensitive member 41, and primarily transfers the toner images of respective colors of Y, M, C, and K formed on the photosensitive member 41 to the intermediate transfer belt B.

Since structures and operations of the image forming units Y, M, C, and K are the same as each other, a series of image forming operations performed by the image forming device 4 will be described below taking the yellow image forming unit Y as an example.

The photosensitive member 41 includes an organic photosensitive member having a photosensitive layer made of a resin in which an organic photoconductor is contained on the outer circumferential surface of a drum-shaped metallic base, and is rotationally driven counterclockwise in the figure. Examples of the resin constituting the photosensitive layer include polycarbonate resin, silicone resin, polystyrene resin, acrylic resin, methacrylic resin, epoxy resin, polyurethane resin, vinyl chloride resin, and melamine resin, for example.

A charging apparatus 42 charges the photosensitive member 41 to a certain potential by using a charger.

An exposure apparatus 43 exposes a non-image area of the photosensitive member 41 on the basis of image data Dy from the controller 10, removes electric charge of an exposed portion, and forms an electrostatic latent image in an image area of the photosensitive member 41.

A developing apparatus 44 supplies toner that is developing powder onto the electrostatic latent image formed on the photosensitive member 41 to form a yellow toner image on the photosensitive member 41.

A primary transfer roller 45 primarily transfers the yellow toner image formed on the photosensitive member 41 to the intermediate transfer belt B.

Similarly, the other image forming units M, C, and K primarily transfer magenta, cyan, and black toner images to the intermediate transfer belt B. As a result, a color toner image of each color of Y, M, C, and K is formed on the intermediate transfer belt B.

The intermediate transfer belt B is a semiconductive endless belt suspended and rotatably supported by a plurality of rollers, and is rotated clockwise in the figure as the roller rotates. The intermediate transfer belt B is press-contacted to each facing photosensitive member 41 by the primary transfer roller 45. A transfer current corresponding to an applied voltage flows in each primary transfer roller 45. As a result, each toner image developed on the surface of the corresponding photosensitive member 41 is primarily transferred sequentially to the intermediate transfer belt B by the corresponding primary transfer roller 45.

A secondary transfer apparatus (transferee) 46 includes a secondary transfer roller pair 461, and secondarily transfers, to the sheet P, the toner image primarily transferred to the intermediate transfer belt B. In the secondary transfer roller pair (transfer member; upstream side conveying member) 461, one roller of a pair of rollers is pressed against the intermediate transfer belt B, and the other roller constitutes one of the plurality of rollers around which the intermediate transfer belt B is wound. The sheet P passes through a transfer nip formed between the pair of rollers, whereby the secondary transfer roller pair 461 secondarily transfers the toner image on the intermediate transfer belt B to the sheet P conveyed from sheet feeding trays 51 to 53 of the sheet feeding device 5.

The fixing apparatus (fixer) F includes a fixing roller pair F1 and performs fixing processing for fixing the toner image transferred to the sheet P. The sheet P passes through a fixing nip formed between a pair of rollers, whereby the fixing roller pair F1 (fixing member; downstream side conveying member) heats and pressurizes the sheet P to which the toner image is transferred to fix an image on the sheet.

The image forming device 4 heats and pressurizes the sheet P to which the toner images of Y, M, C, and K colors are secondarily transferred, by the fixing apparatus F, and then discharges the sheet P out of the apparatus through a predetermined conveying path.

The above is the series of image forming operations by the image forming device 4.

Besides being constituted by a pair of rollers (fixing roller pair F1), the fixing apparatus F can broadly adopt configurations including a pair of rotating members, such as a belt system using a belt and a pad system using a pad.

A cleaning apparatus 47 removes residues such as residual toner and sheet dust remaining on the surface of the photosensitive member 41 after the primary transfer. The cleaning apparatus 47 adopts a blade cleaning method in which a flat plate (sheet-like) cleaning blade made of an elastic body (for example, polyurethane rubber) is brought into contact with the photosensitive member 41.

A cleaning apparatus 48 removes residues remaining on the intermediate transfer belt B after the secondary transfer.

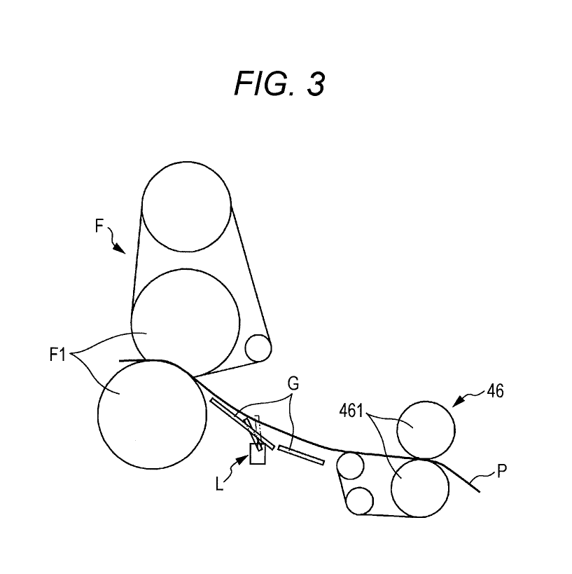

Between the secondary transfer roller pair 461 and the fixing roller pair F1, as illustrated in FIG. 3, a conveying guide G is provided configured to be capable of forming a loop downward with respect to the conveyed sheet. On the conveying guide G, a contact type loop detector L is provided that detects the loop amount of the loop formed on the sheet between the secondary transfer roller pair 461 and the fixing roller pair F1.

The loop detector L includes an actuator that is displaced in accordance with a loop degree of the sheet (loop amount), and a photosensor that outputs a detection signal (ON/OFF of loop detection) in accordance with the displacement of the actuator, to the controller 10.

The sheet feeding device 5 includes the plurality of sheet feeding trays 51 to 53, and accommodates a plurality of the sheets P of different types in the sheet feeding trays 51 to 53. The sheet feeding device 5 feeds the accommodated sheet P by a predetermined conveying path to the image forming device 4.

The storage device 6 includes a hard disk drive (HDD), a semiconductor memory, and the like, and stores data such as program data and various setting data to be readable and writable from the controller 10.

The operation display device 7 includes, for example, a liquid crystal display (LCD) with a touch screen, and functions as a display device 71 and an operation device 72.

The display device 71 displays various types of operation screens, a state of operating conditions of functions, and the like, in accordance with a display control signal input from the controller 10. In addition, touch operation by a user is accepted and an operation signal is output to the controller 10.

The operation device 72 includes various types of operation keys such as a ten key, and a start key, and receives various types of input operations by a user, and outputs an operation signal to the controller 10. By operating the operation display device 7, the user can perform settings relating to image formation such as an image quality setting, a magnification setting, an application setting, an output setting, and a sheet setting, sheet conveying instruction, stop operation of the apparatus, and the like.

The controller 10 includes a CPU, RAM, ROM, and the like, and the CPU deploys, in the RAM, various programs stored in the ROM, cooperates with the various deployed programs, and comprehensively controls operations of the devices of the image forming apparatus 1, such as the automatic document conveying device 2, the scanner device 3, the image forming device 4, the sheet feeding device 5, the storage device 6, the operation display device 7, and the loop detector L (see FIG. 2). For example, the controller 10 inputs the electric signal from the scanner device 3 to perform various types of image processing, and outputs image data Dy, Dm, Dc, and Dk of respective colors of Y, M, C, and K generated by the image processing, to the image forming device 4. In addition, the controller 10 controls the operation of the image forming device 4 to form an image on the sheet P.

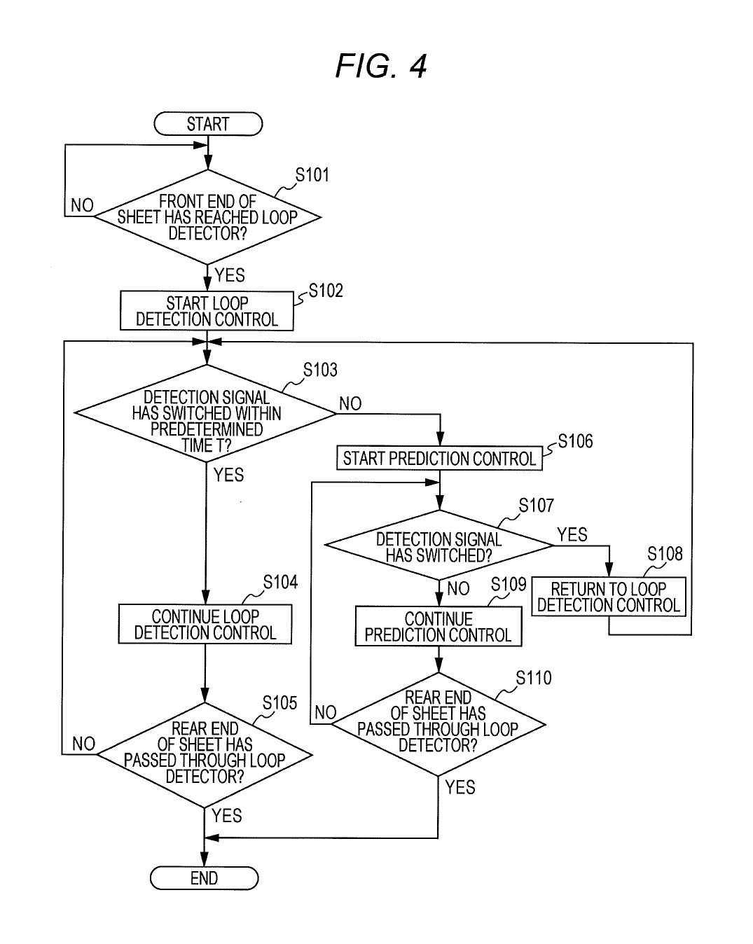

Next, operation of the image forming apparatus 1 according to the present embodiment will be described with reference to a flowchart of FIG. 4. The operation is started when the controller 10 receives a print job and starts sheet feeding.

First, the controller 10 determines whether or not the front end of the sheet has reached the loop detector L (step S101). Specifically, in a case where a detection signal indicating loop detection ON is output from the loop detector L, the controller 10 determines that the front end of the sheet has reached the loop detector L.

In a case where it is determined that the front end of the sheet has reached the loop detector L (step S101: YES), the controller 10 proceeds to the next step S102.

On the other hand, in a case where it is determined that the front end of the sheet has not reached the loop detector L (step S101: NO), the controller 10 repeats the processing of step S101 until the front end of the sheet reaches the loop detector L.

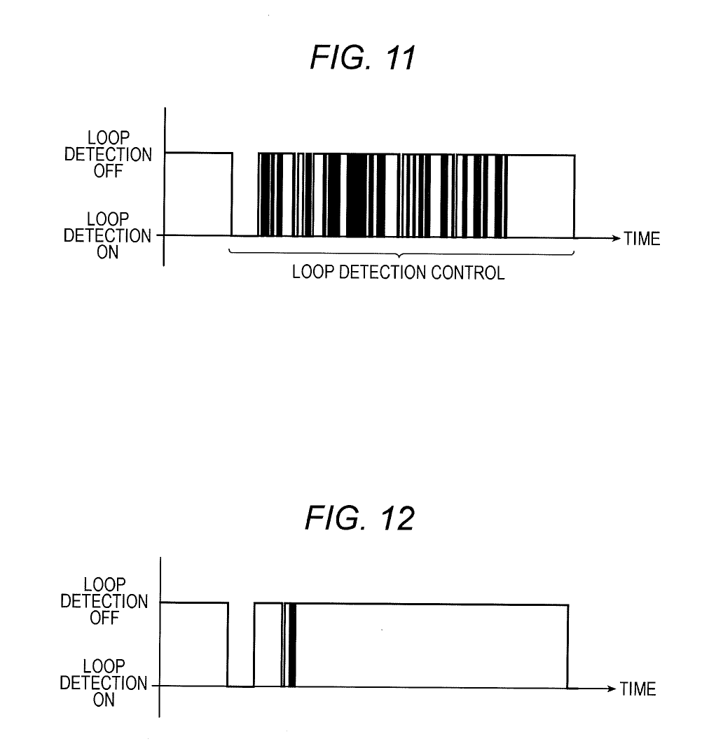

Next, the controller 10 starts loop detection control (normal control) (step S102). Here, the loop detection control means control in which the controller 10 conveys the sheet while the loop amount is kept constant, by repeatedly performing at predetermined intervals, control (hereinafter referred to as high speed control) of setting the conveying speed of the fixing roller pair F1 to a speed (first conveying speed) V1 faster than the conveying speed of the secondary transfer roller pair 461, to decrease the loop amount, in a case where the loop detector L has detected the loop (loop detection ON), and control (hereinafter referred to as low speed control) of setting the conveying speed of the fixing roller pair F1 to a speed (second conveying speed) V2 slower than the conveying speed of the secondary transfer roller pair 461, to increase the loop amount, in a case where the loop detector L has not detected the loop (loop detection OFF) (see FIG. 11).

Next, the controller 10 determines whether or not the detection signal (ON/OFF of the loop detection) of the loop detector L has been switched within a predetermined period of time (first predetermined period of time) T (step S103). That is, the loop detection control started in step S102 is a control in which the detection signal is switched within the predetermined period of time T by repeatedly performing the high speed control and the low speed control at predetermined intervals. Therefore, if the loop detection control is normally performed, the detection signal should have been switched within the predetermined period of time T. Therefore, in step S103, to determine whether or not the loop detection control is normally performed, it is determined whether or not the detection signal has been switched within the predetermined period of time T.

In a case where it is determined that the detection signal of the loop detector L has been switched within the predetermined period of time T (step S103: YES), the controller 10 determines that the loop detection control is normally performed and continues the loop detection control (step S104).

On the other hand, in a case where it is determined that the detection signal of the loop detector L has not been switched within the predetermined period of time T (step S103: NO), the controller 10 determines that there is a possibility that the loop detection control is not normally performed (that is, a distorted loop has occurred on the sheet), and proceeds to step S106.

Next, the controller 10 determines whether or not the rear end of the sheet has passed through the loop detector L (step S105). Specifically, the controller 10 determines whether or not the rear end of the sheet has passed through the loop detector L, by a timing sensor (not illustrated).

In a case where it is determined that the rear end of the sheet has passed through the loop detector L (step S105: YES), the controller 10 ends the processing.

On the other hand, in a case where it is determined that the rear end of the sheet has not passed through the loop detector L (step S105: NO), the controller 10 proceeds to step S103, and again determines whether or not the detection signal of the loop detector L has been switched within the predetermined period of time T.

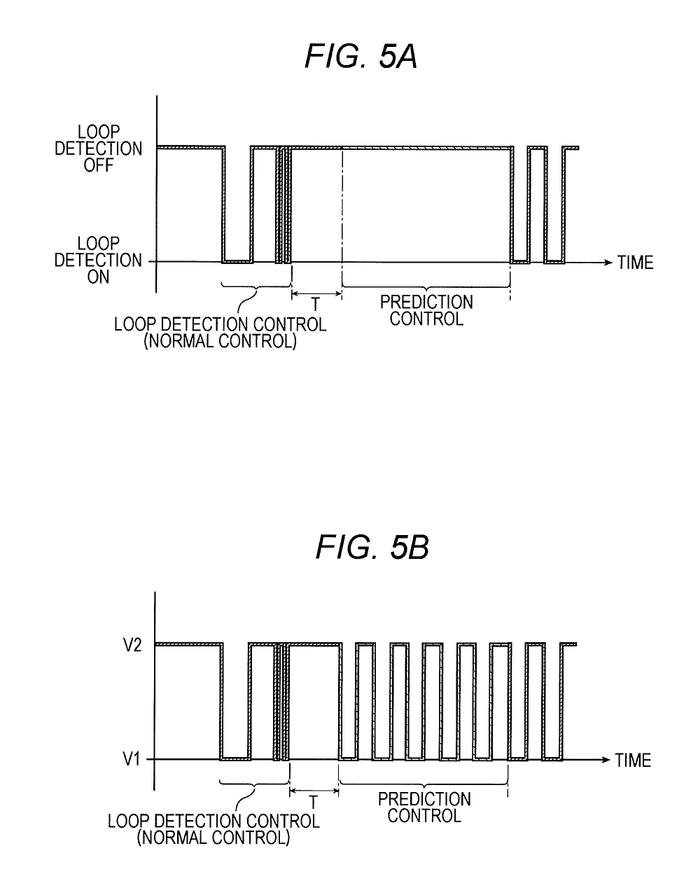

In step S106, the controller 10 starts prediction control. Here, the prediction control means control in which in a case where the detection signal of the loop detector L is not switched within the predetermined period of time T (the loop detection OFF continues for at least the predetermined period of time T) (see FIG. 5A), it is determined that the distorted loop has occurred on the sheet, and the high speed control and the low speed control are repeatedly performed at predetermined intervals and the loop amount is controlled (see FIG. 5B).

That is, during the loop detection control, the conveying speed of the fixing roller pair F1 is switched in accordance with the detection signal of the loop detector L; however, if the loop detection OFF continues for at least the predetermined period of time T and switching to the prediction control is performed, the detection signal of the loop detector L continues to be in the loop detection OFF state (see FIG. 5A), and the conveying speed of the fixing roller pair F1 repeats the high speed control and the low speed control at predetermined intervals during the loop detection OFF (see FIG. 5B).

Here, when the period of time (first period of time) of operation with the high speed control at the first conveying speed V1 is T1 and the period of time (second period of time) of operation with the low speed control at the second conveying speed V2 is T2, an example of a method of determining the first period of time T1 and the second period of time T2 is a method of determination based on the sheet type of the sheet to be conveyed. The sheet type of the sheet influences whether or not the sheet tends to have the distorted loop. Therefore, in a case of a condition in which the sheet tends to have the distorted loop, control is performed of finely performing switching by making the first period of time T1 and the second period of time T2 shorter than those in a condition in which the sheet does not tend to have the distorted loop so that the distorted loop does not expand, and control is performed of making the first period of time T1 longer than the second period of time T2 to decrease the loop amount, whereby expansion of the distorted loop can be suppressed.

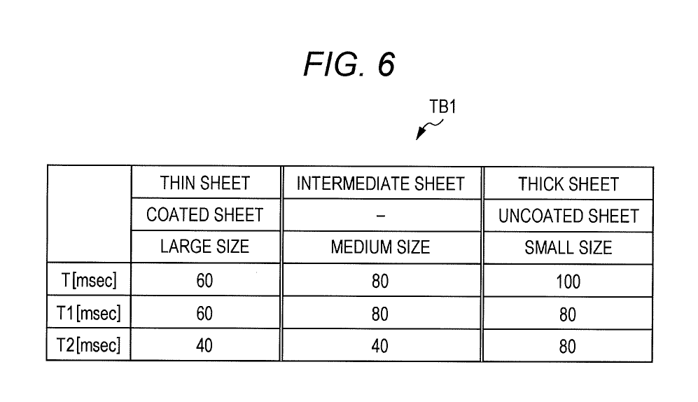

FIG. 6 illustrates an example of a table TB1 illustrating a correspondence between the sheet types and the predetermined period of time T, the first period of time T1, and the second period of time T2. In the example illustrated in FIG. 6, an example of the sheet type condition, sheet thickness, whether it is coated sheet or not, and sheet size are cited. In a case where the sheet is a thin sheet (basis weight not more than 105 gsm; there is no stiffness), in a case where the sheet is a coated sheet, or in a case where the sheet is a large size sheet (length at least 600 mm), the sheet tends to have the distorted loop, so that the first period of time T1 and the second period of time T2 are made shorter than those in the condition in which the sheet does not tend to have the distorted loop, and the first period of time T1 is made longer than the second period of time T2. On the other hand, in a case where the sheet is a thick sheet (basis weight at least 177 gsm; there is stiffness), in a case where the sheet is an uncoated sheet, or in a case where the sheet is a small size sheet (length not more than 487 mm), the sheet does not tend to have the distorted loop, so that the first period of time T1 and the second period of time T2 are made longer than those in the condition in which the sheet tends to have the distorted loop, and since it is not necessary to perform control to decrease the loop amount, the lengths of the first period of time T1 and the second period of time T2 are made to be the same. In a case where the sheet is an intermediate sheet (basis weight greater than or equal to 106 gsm and less than or equal to 176 gsm) or in a case where the sheet is a medium size sheet (length 488 or more and less than 600 mm), intermediate control between those for the thin sheet and the thick sheet is performed.

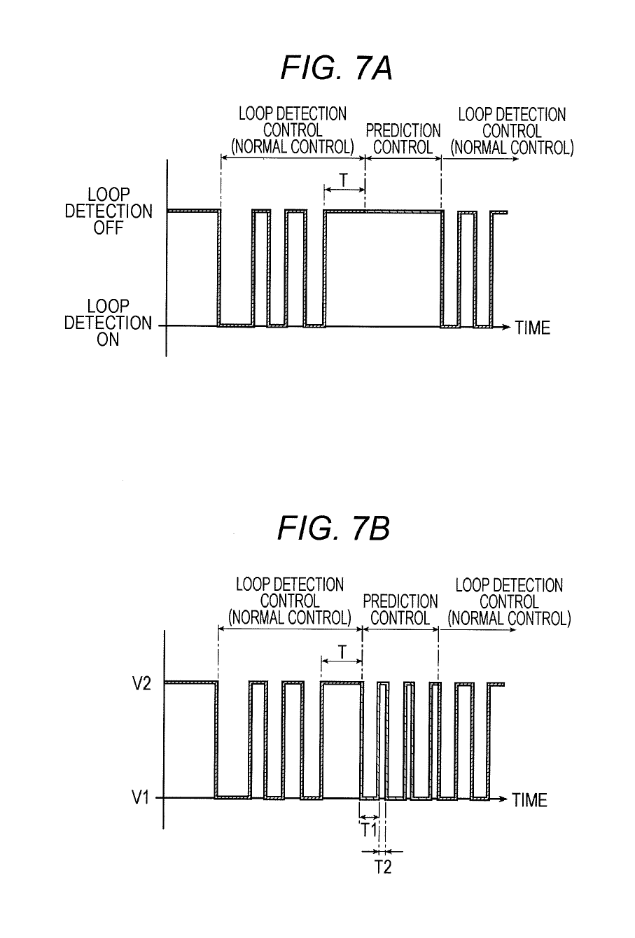

Another example of the method of determining the first period of time T1 and the second period of time T2 is a method of performing control such that the first period of time T1 is longer than the second period of time T2 (see FIG. 7B) while the detection signal of the loop detector L is in the loop detection OFF state (see FIG. 7A). That is, regardless of the sheet type, by performing control such that the first period of time T1 is longer than the second period of time T2, the control to decrease the loop amount can be easily performed, so that expansion of the distorted loop can be easily suppressed.

Another example of the method of determining the first period of time T1 and the second period of time T2 is a method of determining the first period of time T1 and the second period of time T2 on the basis of the detection signal during the normal control from the start of the normal control to the lapse of a predetermined period of time T. During the normal control, the conveying speed of the fixing roller pair F1 is switched on the basis of the detection signal (actual measurement value) of the loop detector L. Therefore, by applying an ON/OFF cycle of the detection signal during the normal control as it is, a possibility can be enhanced that the loop amount can be controlled to be constant.

Another example of the method of determining the first period of time T1 and the second period of time T2 is a method of determining the first period of time T1 and the second period of time T2 on the basis of a duty ratio of the detection signal during the normal control. That is, the ON/OFF cycle of the detection signal during the normal control is not applied as it is, but the first period of time T1 and the second period of time T2 may be determined to have the same ratio as the ON/OFF cycle of the detection signal during the normal control. For example, in a case where the ON/OFF cycle of the detection signal during the normal control is 50 ms/30 ms, to make the ratio between the first period of time T1 and the second period of time T2 5:3, for example, the periods may be determined such that the first period of time T1 is 40 ms and the second period of time T2 is 24 ms, or the first period of time T1 is 60 ms and the second period of time T2 is 36 ms.

Another example of the method of determining the first period of time T1 and the second period of time T2 is a method of determining the first period of time T1 and the second period of time T2 on the basis of the detection signal during the normal control of an arbitrary sheet. That is, in a case where it is necessary to perform the prediction control, even in the case of following the detection signal during the normal control of another sheet, the possibility can be enhanced that the loop amount can be controlled to be constant. Here, the distorted loop or sheet flip-up is greatly affected by stiffness of the sheet. For example, in the case of a sheet with low stiffness (for example, OK top coat 128 gsm), the distorted loop or sheet flip-up tends to occur, and in the case of a sheet with high stiffness (for example, POD top coat 128 gsm), the distorted loop or sheet flip-up does not tend to occur. Therefore, for example, the ON/OFF cycle of the detection signal during the normal control of the POD top coat 128 gsm on which the distorted loop or sheet flip-up does not tend to occur is applied to the prediction control of the OK top coat 128 gsm on which the distorted loop or sheet flip-up tends to occur, whereby the possibility can be enhanced that the loop amount can be controlled to be constant.

Next, the controller 10 determines whether or not the detection signal of the loop detector L (ON/OFF of the loop detection) has been switched (step S107). That is, the controller 10 determines whether or not the loop has been normally formed on the sheet and the loop has been detected by the loop detector L, due to the start of the prediction control in step S106.

In a case where it is determined that the detection signal of the loop detector L has been switched (step S107: YES), the controller 10 determines that the loop has been normally formed on the sheet and returns to the loop detection control that is the normal control (step S108). After that, the controller 10 proceeds to step S103, and again determines whether or not the detection signal of the loop detector L has been switched within the predetermined period of time T.

On the other hand, in a case where it is determined that the detection signal of the loop detector L has not been switched (step S107: NO), the controller 10 determines that the loop has not been normally formed on the sheet and continues the prediction control (step S109).

Next, the controller 10 determines whether or not the rear end of the sheet has passed through the loop detector L (step S110).

In a case where it is determined that the rear end of the sheet has passed through the loop detector L (step S110: YES), the controller 10 ends the processing.

On the other hand, in a case where it is determined that the rear end of the sheet has not passed through the loop detector L (step S110: NO), the controller 10 proceeds to step S107, and again determines whether or not the detection signal of the loop detector L has been switched.

As described above, the image forming apparatus 1 according to the present embodiment includes the loop detector L that detects the loop amount of the loop formed on the sheet between the upstream side conveying member (the secondary transfer roller pair 461) and the downstream side conveying member (the fixing roller pair F1) that convey the sheet, and the controller 10 that controls the loop amount on the basis of the detection signal of the loop detector L. In addition, in a case where it is determined that the distorted loop has occurred on the sheet on the basis of the detection signal of the loop detector L, the controller 10 performs prediction control of the loop amount.

Therefore, with the image forming apparatus 1 according to the present embodiment, it is possible to predict occurrence of the distorted loop and control the loop amount, so that the loop amount can be kept constant even in a case where the front/back difference occurs between the conveying speeds of the upstream side conveying member and the downstream side conveying member. Therefore, the distorted loop or sheet flip-up can be suppressed, and occurrence of transfer misalignment or magnification failure can be suppressed. In addition, occurrence of an upper loop can be suppressed, so that occurrence of image rubbing can be suppressed.

With the image forming apparatus 1 according to the present embodiment, in a case where the detection signal of the loop detector L is not switched for at least the first predetermined period of time (predetermined period of time T), the controller 10 determines that the distorted loop has occurred.

Therefore, with the image forming apparatus 1 according to the present embodiment, the occurrence of the distorted loop can be more accurately predicted, so that the loop amount can be kept constant more reliably.

With the image forming apparatus 1 according to the present embodiment, when the prediction control of loop amount is performed, the controller 10 repeatedly performs the control of setting the conveying speed of the downstream side conveying member to the first conveying speed V1 faster than the conveying speed of the upstream side conveying member for the first period of time T1, and the control of setting to the second conveying speed V2 slower than the conveying speed of the conveying speed of the upstream side conveying member for the second period of time T2.

Therefore, with the image forming apparatus 1 according to the present embodiment, it is possible to alternately apply to the sheet force to pull the sheet and force to bend the sheet during the prediction control, so that expansion of the distorted loop can be suppressed.

With the image forming apparatus 1 according to the present embodiment, the controller 10 determines the first period of time T1 and the second period of time T2 on the basis of the sheet type of the sheet.

Therefore, with the image forming apparatus 1 according to the present embodiment, the prediction control can be performed in consideration of whether or not the conveyed sheet tends to have the distorted loop, so that expansion of the distorted loop can be precisely suppressed.

With the image forming apparatus 1 according to the present embodiment, the controller 10 performs control such that the first period of time T1 is longer than the second period of time T2.

Therefore, with the image forming apparatus 1 according to the present embodiment, control to decrease the loop amount can be easily performed, so that expansion of the distorted loop can be easily suppressed.

With the image forming apparatus 1 according to the present embodiment, the controller 10 determines the first period of time T1 and the second period of time T2 on the basis of the detection signal during the normal control before performing the prediction control.

Therefore, with the image forming apparatus 1 according to the present embodiment, it is possible to use the ON/OFF cycle of the detection signal of when the loop amount could have been controlled to be constant, so that the possibility can be enhanced that the loop amount can be controlled to be constant.

With the image forming apparatus 1 according to the present embodiment, the controller 10 determines the first period of time T1 and the second period of time T2 on the basis of the duty ratio of the detection signal during the normal control before performing the prediction control.

Therefore, with the image forming apparatus 1 according to the present embodiment, the prediction control can be performed on the basis of the ratio of the ON/OFF cycle of the detection signal of when the loop amount could have been controlled to be constant, so that the possibility can be enhanced that the loop amount can be controlled to be constant.

With the image forming apparatus 1 according to the present embodiment, the controller 10 determines the first period of time T1 and the second period of time T2 on the basis of the detection signal during the normal control of the arbitrary sheet.

Therefore, with the image forming apparatus 1 according to the present embodiment, it is possible to use the ON/OFF cycle of the detection signal during the normal control of the sheet in which the distorted loop or sheet flip-up does not tend to occur, so that the possibility can be enhanced that the loop amount can be controlled to be constant.

With the image forming apparatus 1 according to the present embodiment, the controller 10 returns to the normal control in a case where the detection signal is switched after the start of the prediction control.

Therefore, with the image forming apparatus 1 according to the present embodiment, it is possible to return to the normal control when it is determined that the loop has been normally formed on the sheet, so that unnecessary prediction control is not performed, and more stable loop amount control can be performed.

In the above, the present invention has been specifically described on the basis of the embodiment according to the present invention; however, the present invention is not limited to the above-described embodiment, and can be modified within the scope not departing from the gist thereof.

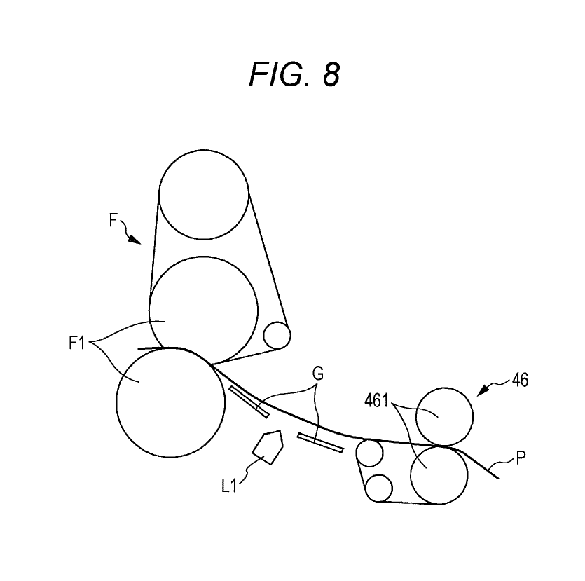

For example, in the above-described embodiment, the configuration using the contact type loop detector L has been described as an example; however, the present invention is not limited thereto. For example, instead of using the contact type loop detector L, as illustrated in FIG. 8, a non-contact type loop detector L1 may be used, such as a laser displacement meter. In a case where the non-contact type loop detector L1 is used, the device may be provided on the back surface side of the sheet (see FIG. 8), or may be provided on the front surface side of the sheet.

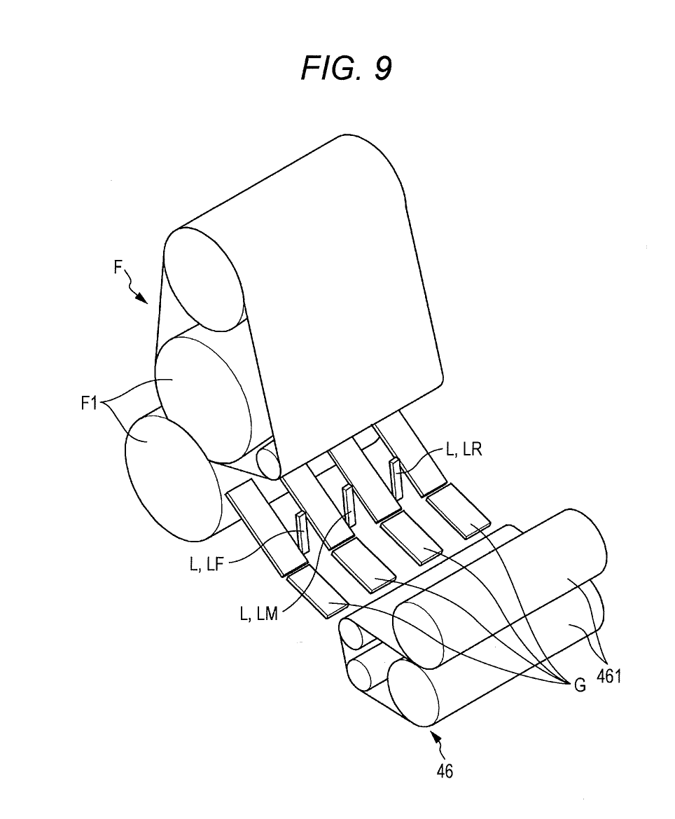

In the above-described embodiment, the configuration using one loop detector L is illustrated as an example; however, the present invention is not limited thereto. For example, as illustrated in FIG. 9, a configuration may be used in which a plurality of (three in FIG. 9) the loop detectors L (LF, LM, and LR in FIG. 9) is arranged in the width direction. In the example illustrated in FIG. 9, in a case where the detection signals of the loop detector LM at the center and either one of the loop detectors LF and LR at both ends are switched from ON to OFF (or from OFF to ON), it is determined that the distorted loop has occurred on the sheet, and switching is performed from the normal control to the prediction control. In addition, in a case where two loop detectors L are used, in a case where the detection signal of either one of the two loop detectors L is switched from ON to OFF (or from OFF to ON), it is determined that the distorted loop has occurred on the sheet, and switching is performed from the normal control to the prediction control. In addition, in a case where at least four loop detectors L are used, in a case where the detection signals of at least two adjacent loop detectors L are switched from ON to OFF (however, except for a case where the detection signals of all the loop detectors L are switched to OFF), it is determined that the distorted loop has occurred on the sheet, and switching is performed from the normal control to the prediction control. By using this determination method, mere sheet fluttering is not erroneously determined as the distorted loop, so that appropriate loop amount control can be performed.

As described above, by determining that the distorted loop has occurred on the basis of a detection pattern of the plurality of loop detectors L (a pattern in which the detection signals of at least two adjacent loop detectors L are switched), occurrence of the distorted loop can be predicted in a shorter period of time, so that expansion of the distorted loop can be suppressed more reliably.

In the above modification, the configuration in which the plurality of loop detectors L is arranged in the width direction has been described as an example; however, the present invention is not limited thereto, and for example, a configuration may be used in which the plurality of loop detectors L is arranged in the conveying direction.

As another modification, control may be performed such that in a case where the detection signal of the loop detector L is not switched for at least a predetermined period of time (the second predetermined period of time) T3 after the start of the prediction control, the conveying speed of the fixing roller pair F1 is set to the second conveying speed V2 until the detection signal is switched, and in a case where the detection signal is switched, the control returns to the normal control.

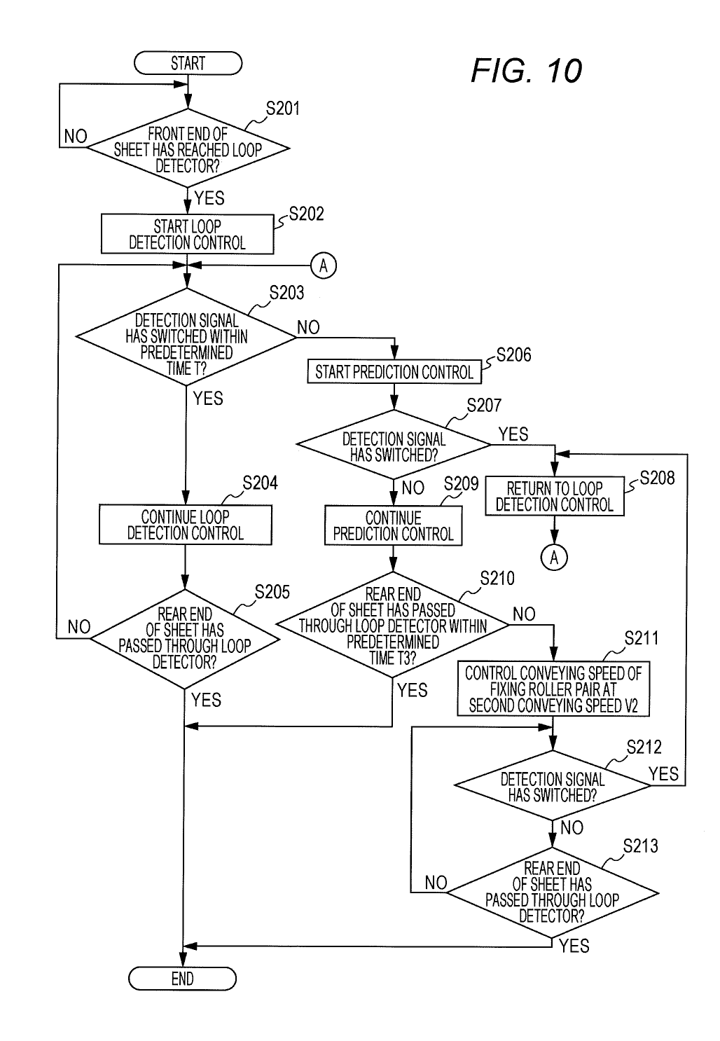

Hereinafter, operation of the image forming apparatus 1 according to the modification will be described with reference to the flowchart of FIG. 10.

First, the controller 10 performs processing from step S201 to step S209. The processing from step S201 to S209 is similar to the processing from step S101 to S109 of FIG. 4 in the embodiment, the description thereof is omitted.

Next, the controller 10 determines whether or not the rear end of the sheet has passed through the loop detector L within the predetermined period of time T3 (step S210).

In a case where it is determined that the rear end of the sheet has passed through the loop detector L within the predetermined period of time T3 (step S210: YES), the controller 10 ends the processing.

On the other hand, in a case where it is determined that the rear end of the sheet has not passed through the loop detector L within the predetermined period of time T3 (step S210: NO), the controller 10 controls the conveying speed of the fixing roller pair F1 to the second conveying speed V2 (step S211). This is because, in a case where the detection signal of the loop detector L is not switched for at least the predetermined period of time (the second predetermined period of time) T3 after the start of the prediction control, the fixing roller pair F1 pulls the sheet excessively, and the sheet is brought into a state of being fully extended between the secondary transfer roller pair 461 and the fixing roller pair F1, and there is a possibility that image misalignment or the like occurs. Therefore, by setting the conveying speed of the fixing roller pair F1 to the second conveying speed V2, the situation can be suppressed where the fixing roller pair F1 pulls the sheet excessively.

Next, the controller 10 determines whether or not the detection signal (ON/OFF of the loop detection) of the loop detector L has been switched (step S212). That is, the controller 10 determines whether or not excessive pulling of the sheet by the fixing roller pair F1 has been eliminated and the loop has been detected by the loop detector L, due to control of the conveying speed of the fixing roller pair F1 to the second conveying speed V2 in step S211.

In a case where it is determined that the detection signal of the loop detector L has been switched (step S212: YES), the controller 10 determines that the excessive pulling of the sheet by the fixing roller pair F1 has been eliminated, proceeds to step S208, and again returns to the loop detection control that is the normal control. After that, the controller 10 proceeds to step S203, and again determines whether or not the detection signal of the loop detector L has been switched within the predetermined period of time T.

On the other hand, when it is determined that the detection signal of the loop detector L has not been switched (step S212: NO), the controller 10 determines that excessive pulling of the sheet by the fixing roller pair F1 has not been eliminated, and proceeds to S213.

Next, the controller 10 determines whether or not the rear end of the sheet has passed through the loop detector L (step S213).

In a case where it is determined that the rear end of the sheet has passed through the loop detector L (step S213: YES), the controller 10 ends the processing.

On the other hand, in a case where it is determined that the rear end of the sheet has not passed through the loop detector L (step S213: NO), the controller 10 proceeds to S212 while controlling the conveying speed of the fixing roller pair F1 at the second conveying speed V2, and again determines whether or not the detection signal of the loop detector L has been switched.

As described above, in a case where the detection signal is not switched for at least the second predetermined period of time (predetermined period of time T3) after the start of the prediction control, the controller 10 performs control to set the conveying speed of the downstream side conveying member (fixing roller pair F1) to the second conveying speed V2 until the detection signal is switched, and in a case where the detection signal is switched, the controller 10 returns to the normal control, whereby the situation can be suppressed where the fixing roller pair F1 pulls the sheet excessively, so that occurrence of transfer misalignment or magnification failure can be suppressed.

The predetermined period of time T, the first period of time T1, the second period of time T2, and the predetermined period of time T3 may be controlled not only by the method of performing control by measuring the period of time, but also by other methods. For example, a method may be used in which a sheet conveying amount measuring device is included and control is performed on the basis of the conveying amount, or a method may be used in which devices are included such as a drive motor of the fixing roller pair F1 a drive motor of the secondary transfer roller pair 461, and an encoder that measures the number of revolutions and the rotation angle of the sheet conveying roller, and control is performed on the basis of the number of revolutions or the rotation angle.

In the above-described embodiment, the configuration of controlling the loop amount of the loop formed on the sheet between the secondary transfer roller pair 461 and the fixing roller pair F1 has been described as an example; however, the present invention is not limited thereto. That is, any configuration may be used as long as the loop amount is controlled of the loop formed on the sheet between the upstream side conveying member and the downstream side conveying member that convey the sheet, and for example, a configuration may be used in which the loop amount is controlled of the loop formed on the sheet between the secondary transfer roller pair 461 and a timing roller pair provided on the upstream side of the secondary transfer roller pair 461.

Besides, the detailed configuration of each apparatus constituting the image forming apparatus and detailed operation of each apparatus can be appropriately changed without departing from the spirit of the present invention.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus that includes a transferer that transfers a toner image to a sheet and a fixer that thermally fixes the toner image transferred on the sheet by the transferer, and forms an image on the sheet,
the image forming apparatus comprising:
a loop detector that detects a loop amount of a loop formed on the sheet between an upstream side conveying member and a downstream side conveying member that convey the sheet; and
a hardware processor that controls the loop amount on the basis of a detection signal of the loop detector, wherein
the hardware processor performs prediction control of the loop amount in a case where it is determined that a distorted loop has occurred on the sheet on the basis of the detection signal of the loop detector.

2. The image forming apparatus according to claim 1, wherein
the upstream side conveying member is a transfer member of the transferer, and
the downstream side conveying member is a fixing member of the fixer.

3. The image forming apparatus according to claim 2, wherein the fixing member is a fixing roller pair.

4. The image forming apparatus according to claim 1, wherein the hardware processor determines that the distorted loop has occurred in a case where the detection signal of the loop detector is not switched for at least a first predetermined period of time.

5. The image forming apparatus according to claim 1, wherein
the loop detector includes a plurality of the loop detectors, and
the hardware processor determines that the distorted loop has occurred on the basis of a detection pattern of the plurality of loop detectors.

6. The image forming apparatus according to claim 1, wherein, when the prediction control of the loop amount is performed, the hardware processor repeatedly performs control in which a conveying speed of the downstream side conveying member is set to a first conveying speed faster than a conveying speed of the upstream side conveying member for a first period of time, and control in which the conveying speed of the downstream side conveying member is set to a second conveying speed slower than the conveying speed of the upstream side conveying member for a second period of time.

7. The image forming apparatus according to claim 6, wherein the hardware processor determines the first period of time and the second period of time on the basis of a sheet type of the sheet.

8. The image forming apparatus according to claim 6, wherein the hardware processor performs control such that the first period of time is longer than the second period of time.

9. The image forming apparatus according to claim 6, wherein the hardware processor determines the first period of time and the second period of time on the basis of the detection signal during normal control before performing the prediction control.

10. The image forming apparatus according to claim 6, wherein the hardware processor determines the first period of time and the second period of time on the basis of a duty ratio of the detection signal during normal control before performing the prediction control.

11. The image forming apparatus according to claim 6, wherein the hardware processor determines the first period of time and the second period of time on the basis of the detection signal during normal control of an arbitrary sheet.

12. The image forming apparatus according to claim 1, wherein the hardware processor returns to normal control in a case where the detection signal is switched after a start of the prediction control.

13. The image forming apparatus according to claim 6, wherein, in a case where the detection signal is not switched for at least a second predetermined period of time after a start of the prediction control, the hardware processor performs control in which the conveying speed of the downstream side conveying member is set to the second conveying speed until the detection signal is switched, and in a case where the detection signal is switched, the hardware processor returns to normal control.
